(19) United States
(12) Patent Application Publication
(10) Pub. No.: US 2012/0042444 A1
(43) Pub. Date: Feb. 23, 2012

(54) BACK-FLOW PREVENTION WITHIN A HEATER

(75) Inventor: E. KEITH MC QUEEN, Thousand Oaks, CA (US)

(73) Assignee: ZODIAC POOL SYSTEMS, INC., MOORPARK, CA (US)

(21) Appl. No.: 13/211,448

(22) Filed: Aug. 17, 2011

Related U.S. Application Data
(60) Provisional application No. 61/374,689, filed on Aug. 18, 2010.

(51) Int. Cl. E04H 4/14; C02F 1/00

(52) U.S. Cl. 4/493; 210/167.11

(57) ABSTRACT

Disclosed is a heater including a back-flow preventing device located at or adjacent an outlet of the heater. In some embodiments, the back-flow preventing device has an open position and a closed position. When the back-flow preventing device is in the open position, water is able to flow freely through the heater. When back-flow preventing device is in the closed position, water is prevented from flowing or migrating back into the heater.

### RELATED APPLICATION

This application claims the benefit of U.S. Provisional Application Ser. No. 61/374,689 filed Aug. 18, 2010 titled “Back-Flow Prevention Within A Pool Heater,” the content of which is hereby incorporated by reference.

### FIELD OF THE INVENTION

This invention relates to swimming pool heaters, particularly a mechanism to limit or prevent back-flow of water through the heater.

### BACKGROUND

Swimming pool heaters are often installed within close proximity to water treatment devices that add water treatment chemicals and disinfectants to the pool water. Water treatment chemicals in higher concentrations and pH conditions can cause accelerated damage to a heater's heat exchanger. To limit the possible damage to heater heat exchangers, these devices typically must be installed downstream of the heater.

Because most pool equipment is usually close-coupled together, certain conditions allow water to migrate or flow back into the heater. In one scenario, if the chlorine feeder or other water treatment device is close to the heater, when the system is not running it is possible for the stagnant water in the pipes to reach a high chemical concentration and migrate back into the heater. This can cause damage to the heat exchanger.

### BRIEF SUMMARY

The terms “invention,” “the invention,” “this invention” and “the present invention” used in this patent are intended to refer broadly to all of the subject matter of this patent and the patent claims below. Statements containing these terms should be understood to not limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the appropriate portions of the entire specification of this patent, any or all drawings and each claim.

In some embodiments, a pool heater assembly is provided that comprises a heat exchanger defining a fluid inlet and a fluid outlet and a valve configured to prevent fluid that has exited the heat exchanger from returning to the heat exchanger through the fluid outlet. In some embodiments, the system includes a device located downstream of the heat assembly for chemically treating the water.

### BRIEF DESCRIPTION OF THE DRAWINGS

The specification makes reference to the following appended figures, in which use of like reference numerals in different figures is intended to illustrate like or analogous components.

FIG. 1 is a schematic view of a swimming pool heater according to one embodiment.

FIG. 2 is an enlarged cross-sectional view taken at inset circle 5 of FIG. 1.

### DETAILED DESCRIPTION

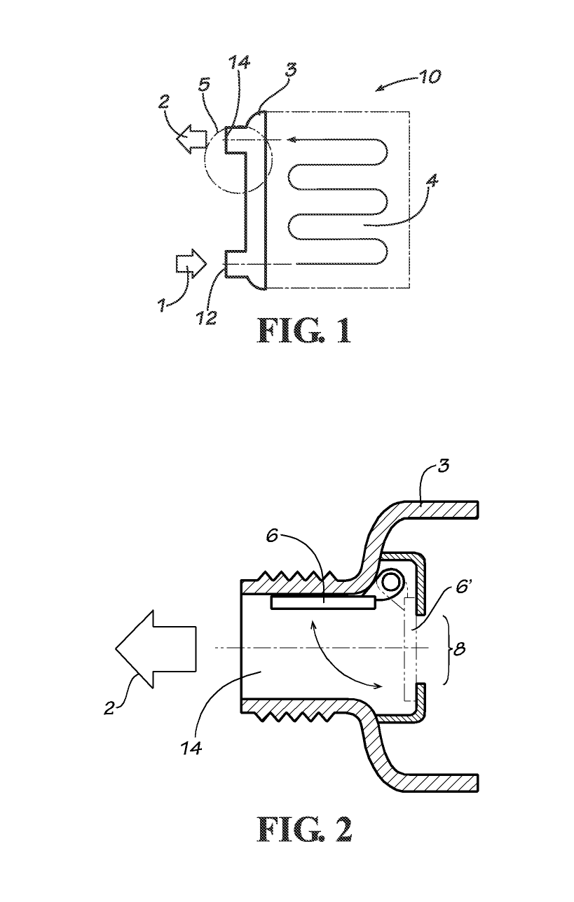

FIG. 1 illustrates a heater 10 having an inlet 12, an outlet 14, a heat exchanging area 4, and a manifold portion 3. Water flow into the heater 10 through inlet 12 is represented by arrow 1, while water flow out of the heater through outlet 14 is represented by arrow 2.

As shown in FIG. 2, outlet 14 includes a back-flow preventing device 6, which in some embodiments is a check valve. Back-flow preventing device has an open position (shown in FIG. 2 as 6) and a closed position (shown in dotted lines in FIG. 2 as 6′). Back-flow preventing device as illustrated in FIG. 2 is a door that pivots between its open and closed positions, although back-flow preventing device may have any other suitable configuration that allows it to move between an open and a closed position. When back-flow preventing device is in the open position (6), water is able to flow freely through the heater. When back-flow preventing device is in the closed position (6′), water is prevented from flowing or migrating back into the heater 10 by way of port 8.

In some embodiments, the back-flow preventing device 6 is biased with a spring or other suitable mechanism for urging the back-flow preventing device from its open position to its closed position to close off port 8 when there is no water flow. In some embodiments, back-flow preventing device is a swing-type check valve, as illustrated in the embodiment shown in FIGS. 1-2. In other embodiments, back-flow preventing device is a poppet type check valve, a butterfly type, or any other suitable type.

Inclusion of a back-flow preventing device such as back-flow preventing device 6 eliminates the need to install a separate check (back flow-prevention) device between components. Although back-flow preventing device 6 is shown located within outlet 14, back-flow preventing device 6 could be positioned adjacent outlet 14 or in any other suitable location to prevent fluid from migrating back into the heater 10 when the back-flow preventing device is in the closed position.

The embodiments described above are illustrative and non-limiting. Many variations of the structures illustrated in the drawings and the materials described are possible and within the scope of this invention.

1. A pool heater assembly comprising:
a. a heat exchanger defining a fluid inlet and a fluid outlet; and
b. a valve configured to prevent fluid that has exited the heat exchanger from returning to the heat exchanger through the fluid outlet.

2. A pool heater assembly according to claim 1 in which the valve is positioned at least partly within the fluid outlet.

3. A pool heater assembly according to claim 1 in which the valve is normally open and configured to close when fluid is not exiting the heat exchanger through the fluid outlet.

4. A pool heater assembly according to claim 3 in which the valve is biased with a spring.

5. A pool heater assembly according to claim 4 in which the valve comprises a door configured to pivot between open and closed positions.

6. A pool heater assembly according to claim 5 in which the heat exchanger comprises a manifold defining the fluid inlet and the fluid outlet.

7. A pool heater assembly according to claim 6 in which the heat exchanger further comprises at least one tube or coil.

8. A conditioning system for a recreational body of water comprising:
a. a heater assembly comprising:
i. a heat exchanger defining a fluid inlet and a fluid outlet; and
ii. a valve configured to prevent fluid that has exited the heat exchanger from returning to the heat exchanger through the fluid outlet; and
b. means, nominally downstream of the heater assembly and in fluid communication therewith, for chemically treating the water.
